(19) United States
(12) Patent Application Publication
(10) Pub. No.: US 2017/0261807 A1
(43) Pub. Date: Sep. 14, 2017

(54) POLARIZER SHEET, LIQUID CRYSTAL DISPLAY DEVICE AND FABRICATING METHOD OF POLARIZER SHEET

(71) Applicants: BOE TECHNOLOGY GROUP CO., LTD., Beijing (CN); HEFEI XINSHENG OPTOELECTRONICS TECHNOLOGY CO., LTD., Hefei City (CN)

(72) Inventors: Liangliang JIANG, Beijing (CN); Ke DAI, Beijing (CN); Yong Jun YOON, Beijing (CN)

(21) Appl. No.: 15/340,337

(22) Filed: Nov. 1, 2016

(30) Foreign Application Priority Data
Mar. 11, 2016 (CN) 201610140463.7

(51) Int. Cl. G02F 1/1335

(52) U.S. Cl. CPC G02F 1/133528; G02F 2202/36; G02F 2203/05; G02B 27/20

(57) ABSTRACT

Embodiments of the present disclosure disclose a polarizer sheet, a liquid crystal display device and a fabricating method of a polarizer sheet a polarizer sheet. The polarizer sheet includes a polarizing layer and an up-conversion luminescence material layer located on a side of the polarizing layer, the up-conversion luminescence material layer being capable of emitting visible light under excitation of an external light.

### TECHNICAL FIELD

Embodiments of the present disclosure relate to a polarizer sheet, a liquid crystal display device and a fabricating method of a polarizer sheet.

### BACKGROUND

In many occasions such as teaching, speaking and so on, a speaker often projects related presentations on a screen, and uses a laser pen to point to the presentations projected on the screen, to enhance an explaining effect. A general process of a viewer seeing a position pointed by the laser pen is that: light emitted from the laser pen irradiates on the projection screen, and is reflected by a surface of the projection screen, and then incident into eyes of the viewer, so that the viewer can see a light spot in the position indicated by the laser pen on the screen.

With development of display technology, a variety of display devices keep emerging. Comparing a large-sized liquid crystal display device with the screen, an image displayed by the liquid crystal display device has higher brightness, so an image display effect is better. Thus the liquid crystal display device is gradually favored and used by people.

### SUMMARY

An embodiment of the present disclosure provides a polarizer sheet, including: a polarizing layer and an up-conversion luminescence material layer located on a side of the polarizing layer, the up-conversion luminescence material layer being capable of emitting visible light under excitation of an external light.

Another embodiment of the present disclosure provides a liquid crystal display device, including: a display panel and an upper polarizer sheet attacked on a display surface of the display panel, wherein, the upper polarizer sheet is the above described polarizer sheet, and the polarizing layer is located between the display panel and the up-conversion luminescence material layer.

Yet another embodiment of the present disclosure provides a fabricating method of a polarizer sheet, including: providing a polarizing layer structure which includes a polarizing layer, forming an up-conversion luminescence material layer on the polarizing layer structure, the up-conversion luminescence material layer being capable of emitting visible light under excitation of external light.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the disclosure.

FIG. 1 is a cross-sectional structural schematic diagram of a polarizer sheet provided by an embodiment of the present disclosure;

FIG. 2 is FIG. 2 is an working principle diagram of using a laser pen to irradiate a liquid crystal display device to show a pointed position according to an embodiment of the present disclosure;

FIG. 3 is another working principle diagram of using a laser pen to irradiate a liquid crystal display device to show a pointed position according to an embodiment of the present disclosure.

### DETAILED DESCRIPTION

In a related art, in a case where a display region of a liquid crystal display device is irradiated by using a laser pen, because an image displayed by the liquid crystal display device has high brightness per se and a reflective index of a polarizer sheet pasted on the display region is low, after that light emitted from the laser pen is reflected by the display region of the liquid crystal display device, a light spot in a pointed position has relatively low brightness, so that a viewer is hard to clearly see the light spot on the liquid crystal display device.

Embodiments of the present disclosure provide a polarizer sheet, a liquid crystal display device and a fabricating method of a polarizer sheet, to realize that a viewer can clearly see a light spot on a position indicated by a laser pen when using the laser pen to point to a liquid crystal display device having high brightness.

The technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

It should be noted that, in an embodiment of the present disclosure, a liquid crystal display device includes a display panel, and the display panel is formed by an array substrate, a color filter substrate, and a liquid crystal layer located between the array substrate and the color filter substrate; the liquid crystal display device further includes an upper polarizer sheet and a lower polarizer sheet, wherein, the upper polarizer sheet is pasted on a display surface of the display panel, that is, for example, on the color filter substrate; and the lower polarizer sheet is pasted on a surface of the display panel opposite to the display surface, that is, for example, on the array substrate. When the liquid crystal display device displays an image, light sequentially passes the lower polarizer sheet, the display panel and the upper polarizer sheet, to complete display of the image. Here, a region on the liquid crystal display device corresponding to the display surface of the display panel is a region for displaying image on the liquid crystal display device which is called a display region.

Referring to FIG. 1, a polarizer sheet 10 provided by an embodiment of the present disclosure includes a polarizing layer 11 for polarizing. Meanwhile, in order to protect the polarizing layer 11 and to prevent the polarizing layer 11 from damages, the polarizer sheet 10 further includes a first protective layer 12 and a second protective layer 13 stacked on two sides of the polarizing layer 11, respectively. In addition, the polarizer sheet 10 further comprises an up-conversion luminescence material layer 14, the up-conversion luminescence material layer 14 is stacked on a side of the first protective layer 12 away from the polarizing layer 11, and the up-conversion luminescence material layer 14 can emit visible light under excitation of a specified external light. Here, the specified external light, for example, is laser.

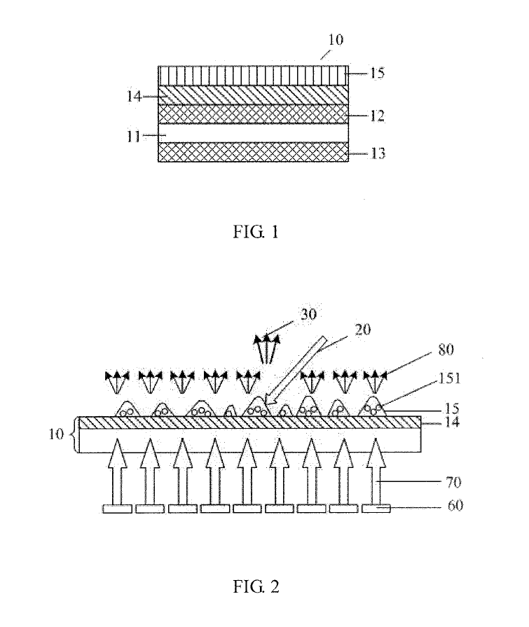

Referring to FIG. 2, the up-conversion luminescence material layer 14 is capable of emitting light having higher energy under excitation of light having lower energy, thus achieving anti-stokes luminescence. According to this property, in the embodiment, the up-conversion luminescence material layer 14 can be excited by specified external light having energy less than that of visible light to emit visible light, and thus achieving initiative light emitting of the up-conversion luminescence material layer 14. Thus, the polarizer sheet 10 including the up-conversion luminescence material layer 14 is applied to a liquid crystal display device, that is, the polarizer sheet 10 is pasted on a display surface of a display panel; when a display region of the liquid crystal display device is to be pointed to by a laser pen, an appropriate laser pen can be selected according to different light emitted from different laser pens. Light 20 emitted from the laser pen is irradiated on the display region of the liquid crystal display device, which can excite the up-conversion luminescence material layer 14 of the polarizer sheet 10 to emit visible light 30, and the visible light 30 is incident into vision of a viewer, and thus the viewer can clearly see a light spot in a position indicated by the laser pen on the liquid crystal display device.

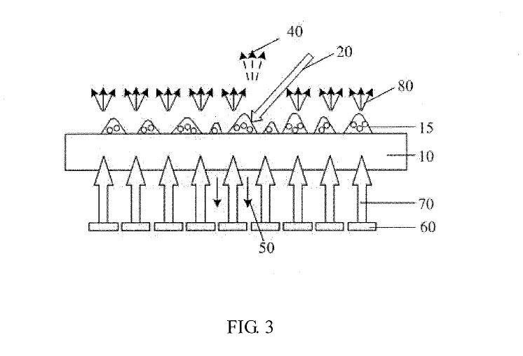

Referring to FIG. 3, in order to improve brightness, contrast and the like of an image displayed by a liquid crystal display device, so as to improve display quality of the liquid crystal display device, a polarizer sheet pasted on a display surface of a display panel usually has high transmittance and low reflective index, for example, the transmittance can be up to 45%, and the reflective index is less than 4%. Therefore, if the polarizer sheet 10 cannot implement a function of initiative light emitting, the light quantity of the light 20 emitted from the laser pen after the reflection of the display area is significantly reduced, and parts of light may pass through the polarizer sheet 10, the quantity of light can be further decreased, so that brightness of the image displayed by the liquid crystal display device can be much higher than that of light spot shown in vision of a viewer, and further the viewer is hard to see the light spot in a position indicated by the laser pen. However, the polarizer sheet 10 in the embodiment adopts an initiative light emitting mode, the emitted visible light 30 has high brightness, and even in an image having high brightness displayed by the liquid crystal display device, the viewer is easy to see the light spot in the position indicated by the laser pen.

For convenience of understanding principle of a working principle of using a laser pen to irradiate a liquid crystal display device to show a pointed position, in FIG. 3, light 20 emitted from the laser pen is reflected by the display region to form light called first light 40, and a portion of light 20 emitted from the laser pen passes through the polarizer sheet 10 to form light called second light 50.

Further, according to the properties of the up-conversion luminescence material layer 14, for example, infrared light having energy less than that of visible light can be selected as the specified external light. Because far-infrared light has relatively low energy, and is not easily absorbed by the up-conversion luminescence material layer 14, the specified external light here, for example, is near-infrared light. Here, the near infrared light has a wavelength, for example, in range of 780 to 2526 nm. For example, the wavelength of the specified external light is about 980 nm. It is worth mentioning that, the infrared light is invisible light, when the near-infrared light emitted by the laser pen irradiates on the liquid crystal display device, there is no light beam between the laser pen and the liquid crystal display device to affect a display effect of the display region, and meanwhile, since energy of the near-infrared light is less than those of ultraviolet light and others, when the near-infrared light irradiates on the liquid crystal display device, liquid crystals and semiconductor devices in the polarizer sheet 10 and the liquid crystal display device are hardly damaged.

The up-conversion luminescence material layer 14 can be made of a conversion emitting material. For example, in order to evenly distribute the up-conversion luminescence material layer 14 on the first protective layer 12, so that each position of the up-conversion luminescence material layer 14 can be excited by the specified external light, the up-conversion luminescence material layer 14 can be made of a nano-particulate conversion emitting material.

Further, the up-conversion luminescence material includes a host material, a sensitizer and an activator, wherein, the host material is a matrix material for generating up-conversion luminescence, and mainly is a compound doped with rare earth ions; the sensitizer is used for absorbing light irradiated on the up-conversion luminescence material layer 14, and transmitting the absorbed light to the host material, so that the host material is excited by the absorbed light; and the activator is used for accelerating reaction processes related in conversion luminescence, to emit the visible light, and efficiency of conversion is improved.

According to different specific compositions of the selected host material, sensitizer and activator, the formed conversion emitting materials are different, and thus the visible light emitted under excitation of the near-infrared laser is also different For example, sodium yttrium fluoride having high conversion luminescent efficiency can be selected as the host material, ytterbium can be selected as the sensitizer and erbium can be selected as the activator, wherein, a mass proportion of sodium yttrium fluoride, ytterbium and erbium can be 75:23:2. The up-conversion luminescence material made of such ingredients can emit green light under excitation of near-infrared light. Color of the green light is bright, so when using a laser pen to point to a display region of a liquid crystal display device is, a viewer is easy to see a green light spot in a position indicated by the laser pen. Of course, the up-conversion luminescence material can be made of other ingredients, so as to emit visible light having other colors under excitation of the near-infrared light, and for example, the up-conversion luminescence material can emit blue light under excitation of the near-infrared light, etc.

In the embodiment, the up-conversion luminescence material layer 14 is additionally arranged in the polarizer sheet 10, if the up-conversion luminescence material layer 14 is designed too thick, not only polarization of the polarizer sheet 10 can be affected, but also requirements on thinning of the liquid crystal display device cannot be met, and thus a display effect of the liquid crystal display device is affected; and if the up-conversion luminescence material layer 14 is designed too thin, an excitation effect of the near-infrared light on the up-conversion luminescence material layer 14 can be still affected, and thus the conversion light emitting efficiency is affected. Therefore, the up-conversion luminescence material layer 14 may have a thickness, for example, in a range of 2 μm to 10 μm. For example, the up-conversion luminescence material layer 14 may have a thickness of 6 μm.

The up-conversion luminescence material layer 14, for example, is made of a nano-particulate conversion emitting material. Here, at least one dimension of the nanoparticles is in a range of 1 to 100 nm. The nano-sized up-conversion luminescence material particles can be closely arranged in the first protective layer 12, to form the up-conversion luminescence material layer 14 having a thickness from 2 μm to 10 μm, and thus a structure of a formed up-conversion luminescence material layer 14 is stable, which is more conducive to the up-conversion luminescence material layer 14 being excited by the near-infrared light.

Referring to FIG. 1 and FIG. 2, in the embodiment, in order to protect the up-conversion luminescence material layer 14, to prevent the up-conversion luminescence material layer 14 from external damages such as being polluted or scratched and so on, so as to ensure normal use and service life of the up-conversion luminescence material layer 14, the polarizer sheet 10 may further include a surface protective film 15, and the surface protective film 15 is stacked on the up-conversion luminescence material layer 14, to protect the up-conversion luminescence material layer 14. Optionally, the surface protective film 15 can be made of silicon dioxide, to form a glass surface protective film 15, for effectively protecting the up-conversion luminescence material layer 14, and not affecting a viewing effect of the liquid crystal display device at the same time.

Referring to FIG. 2, further, a side of the surface protective film 15 away from the up-conversion luminescence material layer 14 can be fabricated to an uneven surface; when the polarizer sheet 10 is pasted on the display panel, the side of the surface protective film 15 away from the up-conversion luminescence material layer 14 is a side facing a viewer, and the side is called a surface of the surface protective film 15 here. When light irradiates on the surface of the surface protective film 15, since the surface is an uneven surface, the light can be reflected at different angles on the uneven surface, thereby preventing the light from being directly incident into eyes, effectively reducing reflective index of the polarizer sheet 10, and preventing occurrence of glare phenomenon, so that the viewer enjoys a better visual effect, and display effect of the liquid crystal display device is improved. Optionally, a fine surface uneven process can be performed on a surface of the surface protective film 15, to form an uneven surface. The surface of the surface layer protective film 15 has a surface roughness of, for example, 0.020 to 0.2 μm. 100271 Referring to FIG. 2, for example, the surface protective film 15 can be formed by particulate silicon dioxide 151, and thus an uneven surface can be formed by distribution of the silicon dioxide particles 151 in a surface portion, and the silicon dioxide particles 151 below the surface portion can be evenly distributed on the up-conversion luminescence material layer 14, so as to fully protect the up-conversion luminescence material layer 14. Optionally, diameters of the silicon dioxide particles 151 are in a range of 10 μm to 20 μm, and the silicon dioxide particles 151 for forming a same surface protective film 15 may include silicon dioxide particles 151 having different diameters, to ensure stability of the formed surface protective film 15.

It should be noted that, in FIG. 2 and FIG. 3, the reference number 60 denotes a color filter; the reference number 70 denotes light passing from the color filter, which is called third light 70; and the reference number 80 denotes light formed after the third light 70 passing through the polarizer sheet 10, which is called fourth light 80.

Referring to FIG. 2and FIG. 3, after passing through the polarizer sheet 10, the third light 70 may pass through the polarizer sheet 10 at different angles due to action of the uneven surface of the surface protective film 15, so that the fourth light 80 having different angles is formed, and a viewing angle of the display region is enlarged.

### Embodiment II

An embodiment of the present disclosure provides a liquid crystal display device, the liquid crystal display device comprises a display panel and an upper polarizer sheet, and the upper polarizer sheet is pasted on a display surface of the display panel. For example, the upper polarizer sheet is the polarizer sheet 10 according to Embodiment 1. In FIG. 2 and FIG. 3, for example, a color filter 60 exemplarily represents a display panel. In this case, FIG. 2 and FIG. 3 exemplarily show the liquid crystal display device provided by Embodiment II.

The liquid crystal display device provided by the embodiment employs the polarizer sheet 10 including the up-conversion luminescence material layer 14 in Embodiment I, and therefore, an appropriate laser pen can be selected, so that light emitted by the laser pen irradiates on a display region of the liquid crystal display device, which can excite the up-conversion luminescence material layer 14 of the polarizer sheet 10 on the display surface to emit visible light, and the visible light is incident into eyes of a viewer_{;} and thus the viewer can clearly see a light spot in a position indicated by the laser pen on the liquid crystal display device having high brightness, to bring convenience to the speaker and the viewer.

For example, a near-infrared laser pen can be selected to irradiate the display region of the liquid crystal display device, and according to different compositions of a forming material of the up-conversion luminescence material layer 14, the up-conversion luminescence material layer 14 emits blue light or green light when being excited by the near-infrared light.

### Embodiment III

An embodiment of the present disclosure provides a fabricating method of a polarizer sheet, including:

stacking and forming a first protective layer, a polarizing layer and a second protective layer sequentially;

stacking and forming an up-conversion luminescence material layer on a side of the first protective layer away from the polarizing layer by using a spin coating process, the up-conversion luminescence material layer being capable of emitting visible light under excitation of specified external light.

In the fabricating method of the polarizer sheet provided by the embodiment of the present disclosure, the up-conversion luminescence material layer is formed on the side of the first protective layer away from the polarizing layer, and the up-conversion luminescence material layer can emit visible light under excitation of specified external light; therefore, if a liquid crystal display device employs a polarizer sheet fabricated by the fabricating method described above, and when using a specified laser pen to point to the liquid crystal display device is pointed, specified external light emitted by the laser pen irradiates on a display region of the liquid crystal display device, which can excite the up-conversion luminescence material layer of the upper polarizer sheet on the display surface to emit visible light, and the visible light is incident into eyes of a viewer, and thus the viewer can clearly see a light spot on the position pointed by the laser pen on the liquid crystal display device having high brightness. Meanwhile, in the embodiment, a forming material of the up-conversion luminescence material layer is coated on the first protective layer by using a spin coating process, so that the material forming of the up-conversion luminescence material layer is evenly distributed on the first protective layer, and thus any position of the up-conversion luminescence material layer can be excited by the specified external light.

Furthermore, in order to protect the up-conversion luminescence material layer, the fabricating method of the polarizer sheet further includes: staking and forming a surface protective film on the up-conversion luminescence material layer by using a spray coating process, a material of the surface protective film is silicon dioxide.

In the solution described above, the forming material (silicon dioxide) of the surface protective film is coated on the up-conversion luminescence material layer by using a spray coating process, so that silicon dioxide is evenly distributed on the up-conversion luminescence material layer, and thus formed glass surface protective film can fully protect the up-conversion luminescence material layer, to prevent the up-conversion luminescence material layer from being polluted or scratched, and ensuring normal use of the up-conversion luminescence material layer and a service life of the polarizer sheet.

In order to improve image display quality of the liquid crystal display device, for example, a side of the surface protective film away from the up-conversion luminescence material layer can be performed a low reflection process or an anti-glare process.

Optionally, the fabricating method of the polarizer sheet can includes:

Step S1: stacking the first protective layer, the polarizing layer and the second protective layer sequentially by adhesive; wherein, the polarizing layer can be made of conventional material such as polyvinyl alcohol and so on, and used for converting light passing therethrough to linear-polarized light having specific polarizing direction, to play a role of polarization; and the first protective layer and the second protective layer can be made of a material such as cellulose triacetate and so on, and used for protecting the polarizing layer, to prevent the polarizing layer from being broken;

Step S2: coating an up-conversion luminescence material on a side of the first protective layer away from the polarizing layer by a spin coating process, to form an up-conversion luminescence material layer, wherein, the up-conversion luminescence material layer is used for emitting visible light under excitation of specified external light, to implement an initiative light emitting function of the polarizer sheet, and thus the visible light having high brightness can be emitted, to be easily identified by a viewer;

Step S3: coating silicon dioxide on the up-conversion luminescence material layer by using a spray coating process, to protect the up-conversion luminescence material layer;

Step S4: stacking an adhesive layer and a release film sequentially on the second protective layer by bonding of adhesive; when an operation of pasting the polarizer sheet on a display panel is performed, the release film is stripped off the polarizer sheet first, and then the adhesive layer is pasted on a display surface of the display panel.

It should be noted that, the fabricating method of the polarizer sheet provided by the embodiment of the present disclosure, for example, is applicable to a fabricating method of an upper polarizer sheet. And a fabricating method of a lower polarizer sheet may not include a step of forming an up-conversion luminescence material layer, and meanwhile, as long as a surface of a surface protective film of the lower polarizer sheet is cleaned.

In addition, it should be understood that, in another example, the polarizing layer 11, the first protective layer 12 and the second protective layer 13 may be provided integrally as a polarizing layer structure. In this case, the fabricating method of the polarizer sheet may include forming an up-conversion luminescence material layer on the polarizing structure.

In addition, the liquid crystal display device provided by the embodiment can be any product or part having a display function, such as a liquid crystal panel, electronic paper, a mobile phone, a tablet computer, a television, a monitor, a laptop computer, a digital photo frame and a navigator, etc.

Although the present disclosure is described in detail hereinbefore with general illustration and embodiments, based on the present disclosure, certain amendments or improvements can be made thereto, which is obvious for those skilled in the art. Therefore, the amendments or improvements made to the present disclosure without departing from the spirit of the present disclosure should be within the scope of the present disclosure.

The present application claims priority of Chinese Patent Application No. 201610140463.7 filed on March 11, 2016, the disclosure of which is incorporated herein by reference in its entirety as part of the present application.

1. A polarizer sheet, comprising: a polarizing layer and a up-conversion luminescence material layer located on a side of the polarizing layer, the up-conversion luminescence material layer being capable of emitting visible light under excitation of an external light.

2. The polarizer sheet according to claim 1, further comprising a first protective layer located on a side of the polarizing layer away from the up-conversion luminescence material layer, and a second protective layer located between the polarizing layer and the up-conversion luminescence material layer.

3. The polarizer sheet according to claim 1, wherein, the up-conversion luminescence material layer is formed by an up-conversion luminescence material including a host material, a sensitizer and an activator.

4. The polarizer sheet according to claim 3, wherein, the up-conversion luminescence material is nano-particulate.

5. The polarizer sheet according to claim 3, wherein, the host material is sodium yttrium fluoride, the sensitizer is ytterbium and the activator is erbium.

6. The polarizer sheet according to claim 1, wherein, the up-conversion luminescence material layer has a thickness in a range of 2 μm to 10 μm.

7. The polarizer sheet according to claim 6, wherein, the up-conversion luminescence material layer has a thickness of 6 μm.

8. The polarizer sheet according to claim 1, wherein, the polarizer sheet further comprises a surface protective film provided on a side of the up-conversion luminescence material layer away from the polarizing layer.

9. The polarizer sheet according to claim 8, wherein, a material of the surface protective film is silicon dioxide.

10. The polarizer sheet according to claim 8, wherein, a side of the surface protective film away from the up-conversion luminescence material layer is an uneven surface with a surface roughness of 0.020 to 0.2 μm.

11. The polarizer sheet according to claim 10, wherein, the surface protective film includes silicon dioxide particles, and diameters of the silicon dioxide particles are within a range of 10 μm to 20 μm.

12. The polarizer sheet according to claim 1, wherein, the external light is laser.

13. The polarizer sheet according to claim 12, wherein, the laser is near-infrared laser.

14. The polarizer sheet according to claim 2, wherein, the external light is laser.

15. The polarizer sheet according to claim 14, wherein, the laser is near-infrared laser.

16. A liquid crystal display device, comprising: a display panel and an upper polarizer sheet attacked on a display surface of the display panel, wherein, the upper polarizer sheet is the polarizer sheet according to claim 1, and the polarizing layer is located between the display panel and the up-conversion luminescence material layer.

17. A fabricating method of a polarizer sheet, comprising:
providing a polarizing layer structure which includes a polarizing layer,
forming an up-conversion luminescence material layer on the polarizing layer structure, the up-conversion luminescence material layer being capable of emitting visible light under excitation of external light.

18. The fabricating method of the polarizer sheet according to claim 17, wherein, the up-conversion luminescence material layer is formed by a spin coating process.

19. The fabricating method of the polarizer sheet according to claim 17, wherein, the polarizing layer structure includes a first protective layer and a second protective layer located on two opposite sides of the polarizing layer respectively.

20. The fabricating method of the polarizer sheet according to claim 17, wherein, the fabricating method of the polarizer sheet further comprises: forming a surface protective film on the up-conversion luminescence material layer by using a spin coating process, the surface protective film being made of silicon dioxide.
